(19) United States
(12) Patent Application Publication
(10) Pub. No.: US 2007/0091464 A1
(43) Pub. Date: Apr. 26, 2007

(54) Modular Catadioptric Projection Optic

(75) Inventor: Christopher Alexay, Keene, NH (US)

Correspondence Address: Christopher Alexay, 310 Marlboro Street, Keene, NH, 03431, US

(73) Assignee: Christopher Alexay, Keene, NH (US)

(21) Appl. No.: 11/163,365

(22) Filed: Oct. 17, 2005

(51) Int. Cl. G02B 17/00

(52) U.S. Cl. 359/726

(57) ABSTRACT

The invention relates to a catadioptric projection optic and more specifically to a versatile projection optic system capable of delivering optical beams of large diameter to remotely located exit pupil with minimal obscuration.

### TECHNICAL FIELD

The invention relates to a projection optic and more particularly to a catadioptric projection optic system modular in nature and capable of projecting optical beams of large diameter with an exit pupil significantly displaced from said projection optic.

### BACKGROUND OF THE INVENTION

The typical embodiment of an infrared scene projection system consists of a scene generator which produces an image of the subject of interest. The thermal energy from the image which is collected by a projection optic that in turn directs the optical energy a displaced distance into a system under test or SUT. A key requirement of the projection optic is to insure that the energy directed by the projector optic properly accommodates the optical properties of the SUT. These aforementioned optical properties include amongst others; the spectral band of energy over which the SUT is to be evaluated, its entrance pupil location and scale, and the angular field of view over which the SUT is to image. Each of these must be met or exceeded by the imaging abilities of the projection optic to insure an accurate evaluation of the SUT. It is necessary to insure that the projector optics exit pupil is positioned a distance which in some cases can exceed a few meters in length, remote from its physical structure and of a scale equal or greater than that of the SUT's entrance pupil in order to prevent blocking or vignetting of the optical energy. The projection optic must likewise accommodate the SUT's angular field of view. The aforementioned facts explain the reason why many projection optics include elements of considerable size.

Throughout their history, infrared scene projection optics have been primarily refractive in nature that is to say relying solely on lens elements to achieve their purpose. Although these refractive projection designs have functioned satisfactorily in many infrared applications from a performance standpoint, they are limited in terms of their versatility. Such refractive embodiments designed for a specific spectral range of wavelengths, are most often incapable of functioning satisfactorily outside the original spectral range for which they were originally designed. Lens material limitations, chromatic aberrations and anti reflection coatings on their surfaces require that the projection optical system be entirely replaced to address a new spectral range of interest.

As previously indicated, the physical size of the elements needed to produce a purely refractive projection optic can be substantial in scale. In addition to the considerable cost associated with their manufacture, such large refractive elements can fall outside the capabilities of most optical shops to produce such lenses. For further information on the optical aspects and limitations of such an approach to infrared projection optics see article by Alexay “The challenges of infrared scene projection optics” Proc. SPIE Vol. 5612, p. 249-257, Electro-Optical and Infrared Systems: Technology and Applications; Ronald G. Driggers, David A. Huckridge; Eds.

In some ways a projection optic can be considered similar to a telescope which is used in a reverse fashion. One critical difference is that most telescope designs are specifically intended for accommodating very modest angular fields of view. As such these designs are typically incapable of producing a satisfactory image over wider angular fields common to those required for infrared scene projection. Since some geometrical aspects of the present invention may be compared to design forms intended for telescope applications, the following clarifications are offered. A catadioptric telescope as described in U.S. Pat. No. 6,888,672 granted to Wise is capable of imaging a diffraction limited image over a selective spectral range. Similar to the preferred embodiment of the present invention, the primary mirror in the Wise telescope is spherical and the re-directing mirror is flat. Chiefly different however in the Wise design, there is placed in between these two reflecting surfaces a first correcting refractive element. It is a contention of the present invention that such placement of this refractive element results in a design which will have an added complexity and greater level of light blockage when used with an angular field of view similar to that of a scene projector. The location of the first corrective element prior to the re-directing flat element necessitates a support structure for this element which falls within the path of the beam projected from the final concave mirror surface. A further added detractor to such a configuration this refractive element is that it discourages the projection optic from having separable reflective and refractive phases to the design and thereby a less favorable format for accommodating a modular interchangeable embodiment more favorable to versatile employment of the projection optic over widely different spectral ranges. In order to alter the Wise design for operation over different spectral ranges outside those of its original intention, the first corrective surface will need to be removed and or replaced. A contention of the present invention is that a more favorable approach to a modular embodiment would locate the refractive correction within the imaging portion of the optic and at a point independent from the reflective portion of the optical path thereby allowing the possibility of replacement of the refractive elements of the optical path without affecting the integrity of the reflective portion.

One approach which allows for the separation of reflective and refractive imaging portions of a catadioptric design is outlined in the patent by Paramythioti U.S. Pat. No. 6,735,014. In this discovery the refractive imaging portion takes a design form with two converging elements, at least one meniscus element and a diverging lens between the meniscus and the rear converging optical unit. Such a configuration results in a minimal refractive element count of four units. It is a point of the present invention to offer a design approach which can facilitate solutions with substantially fewer elements as that described in the Paramythioti patent. A key advantage of the present invention is the judicious employment of aspheric refractive elements to significantly reduce the total lens count to as few as two refractive elements. Furthermore, the Paramythioti patent utilizes two part cemented achromats to correct the errors associated with chromatic aberration in the design. In the preferred embodiment of the present invention, the projection system's optical design utilizes one diffractive phase surface to control the errors associated with chromatic aberration and deliver diffraction limited, flat field imaging.

### SUMMARY OF THE INVENTION

It is the general object of the present invention to provide a catadioptric projection optic which is embodied by modular separable reflective and refractive portions capable of functioning at vastly different spectral ranges with minimal alteration of the system's integrity and capable of diffraction limited imaging performance over regions of the infrared spectrum. It is a particular object of the present invention to provide a relatively simple catadioptric projection optic whose refractive portion consists of elements which are greatly limited in size and cost and which are located in portions of the optical train which facilitate easy replacement. Image quality is achieved according to the present invention by designing the imaging refractive portion or module so as to counter the aberrations stemming from the final concave reflective surface. One technique for designing refractive imaging elements to account for the aberrations originating with a reflective surface is detailed in an article by Offner in Malacara's “Optical Shop Testing”. In design form, a catadioptric projection optic according to the present invention is quite simple comprising only one powered reflective element, one flat reflective redirecting surface and two lens elements. The two lenses are small in relation to both the systems exit pupil and the systems concave mirror. The catadioptric projection optic according to the present invention is compact and modular in nature allowing for interchangeable, less costly subcomponents to achieve different spectral and optical requirements. The preferred configuration of the design positions the redirecting flat mirror in a location proximate to the focal point of the large concave mirror. Such placement enables the optical design to have the minimal amount of light blockage or vignetting of its final projected beam. The only contributors to this blockage in the present invention are the redirecting mirror and the support structure necessary to support it.

### BRIEF DESCRIPTION OF THE DRAWINGS

FIG. 1 is a highly diagrammatic illustration of an infrared scene projection system consisting of a thermal scene generator, projection optic and a system under test or SUT.

FIG. 2 is a diagrammatic illustration of a refractive infrared scene projection optic.

FIG. 3 is a diagrammatic illustration of a catadioptric projection optic according to the present invention with a spherical concave mirror, an entrance pupil of 254 mm displaced a distance of 750 mm from the projector optic, having an effective focal length of 550 mm and an angular field of view of 4.25 degrees suitable for operation over the 8 micron to 12 micron range of the infrared spectrum.

FIG. 4 is a diagrammatic illustration of the refractive portion of the preferred embodiment illustrated in FIG. 3.

FIG. 5 is a diagrammatic illustration of the catadioptric projection optic according to the present invention having optical elements comprising the refractive portion of the system in a form suitable for imaging over the 3 micron to 5 micron range of the infrared spectrum constituting a variant embodiment of the present invention.

FIGS. 6 and 7 are diagrammatic illustrations of a catadioptric projection optic according to the present invention wherein the refractive portion of the design is configured in such a manner as to allow variation or zooming of focal length through axial displacement of refractive elements constituting a variant embodiment of the present invention.

FIG. 8 is a diagrammatic illustration of a catadioptric projection optic including both a refractive imaging portion suitable for 3 micron to 5 micron mid-wavelength (MWIR) infrared imaging and simultaneously a second refractive imaging portion suitable for 8 micron to 12 micron long-wavelength (LWIR) infrared imaging demonstrating a multi-spectral variation of the present invention.

### DETAILED DESCRIPTION OF THE DRAWINGS

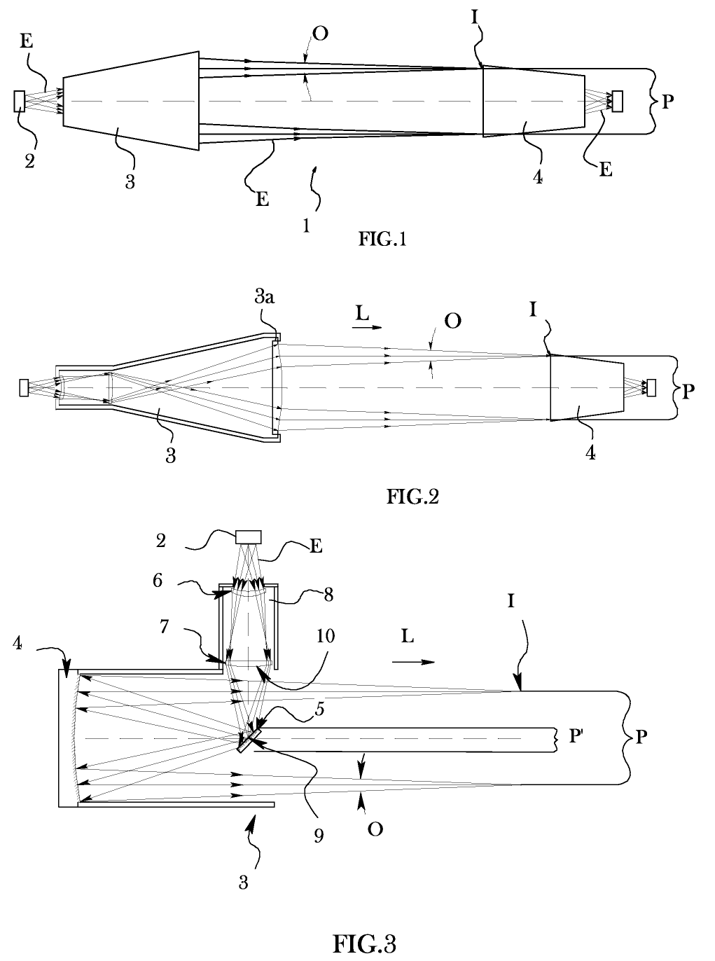

FIG. 1 is a highly diagrammatic representation of an infrared scene simulation system suitable for testing infrared imaging units. The direction of light propagation is indicated by arrow L. The infrared scene simulation system comprises an infrared scene generator source 2, a projection optic 3 and a system under test (SUT) 4. The projection optic 3 is placed within the system so as to collect radiant optical energy E from the infrared scene source 2 and direct it into the SUT 4 in such a manner as to fill the required angular field of view O simultaneously of the SUT 4 and simultaneously fill the entrance pupil P of the SUT 4 at a distant point I remote from the projection optic's 3 physical structure.

FIG. 2 shows a diagrammatic view for a refractive embodiment of an infrared projection optic 3. This figure illustrates the manner in which the optical requirements of the SUT 4 directly determine the physical scale of the projector optic's element (s) 3a positioned nearest the SUT 4. The specific parameters of angular field of view O, SUT pupil location 1, and size P dictate the required physical size of the optical element (s) 3a.

In circumstances where angular field of view O, pupil distance I and pupil size P dictate the need for optical elements of large diameter 3a, cost and fabrication limitations discourage the use of refractive elements. It would be advantageous to instead eliminate the need for larger more costly refractive elements and in their stead utilize significantly less costly reflective elements. More particularly, refractive elements are often significantly limited in their ability to provide good imaging performance over broad spectral ranges. Such limitations in refractive designs often necessitate the complete optic replacement when a requirement for an imaging a different spectral region arises.

FIG. 3 illustrates the interaction between light rays E from the infrared scene generator 2 and the optical projection system 3 configured to illustrate the theoretical operation of the preferred embodiment. This system forms the basis for the design of the preferred embodiment and is effective to provide diffraction limited imaging of the generated infrared scene with large exit pupil size P and appreciable angular field of view O at a location I disposed an appreciable distance from the furthest extent of the projection optic 3. Additionally this system exhibits an unusually small obscuration P′ and utilizes reflective surfaces 4 and 5 in place of less versatile and more costly refractive lens elements. As shown in FIG. 3 a first pair of refractive elements 6 and 7 forming a first imaging module 8 disposed at a predetermined position within the system and is operative to gather incident optical energy E and focally produce an intermediate image point 9 within the focal path of the system and at a point proximate to a redirecting reflective surface 5. In the preferred embodiment the elements 6 and 7 in the imaging module 8 are aspheric in form and include one diffractive surface 10 to control chromatic aberrations in the projection optic. For further information on diffractive surfaces see article by Riedl “Diamond Turned Diffractive Optics for the Infrared” Proc. SPIE Vol. 2540, p. 257-260, Current Developments in Optical Design and Engineering V; Robert E. Fischer, Warren J. Smith; Eds.

The redirecting surface 5 is placed in such a manner so as to alter the direction of the optical path to avoid light obscuration from the refracting elements 6, 7 and their support structure in the first imaging module 8 and to re-direct the collected energy towards a concave spherical mirror surface 4. The spherical mirror surface is disposed at a predetermined position within the optical path of the system and is designed to function in conjunction with the first imaging lens module to correct aberrations originating therein, thus leaving only a very small amount of total aberration in the projection optic.

A particular embodiment of the present invention which has been designed to have an exit pupil of 254 mm a distance of 750 mm from the projector optic's physical extent and an effective focal length of 550 mm and an angular field of view of 4.25 degrees, and for which the refractive first imaging module 8 is comprised of germanium lenses and are optimized for operation in a spectral bandwidth of 8 to 12 micron LWIR radiation is specified by an optical prescription as follows:

| | | Element | | | Distance | Medium |
|---|---|---|---|---|---|---|
| Ref | Sur- | Di- | Radius of | | to Next | Traversed |
| No in | face | ameter | Curvature | Surface | Surface | to Next |
| FIG. | No. | (mm) | (mm) | Type | (mm) | Surface |
| | 0 | 0.0 | Infinity | | Infinity | |
| P | 1 | 254.0 | Infinity | | 1205.00 | |
| 4 | 2 | 350.0 | −948.5 | reflective | 451.42 | air |
| 5 | 3 | 108.1 | Infinity | reflective | 213.24 | air |
| 7 | 4 | 125.9 | 534.6 | asphero- | 15.00 | germanium |
| | | | | diffractive | | |
| | 5 | 125.2 | −1792.8 | spherical | 175.29 | air |
| 6 | 6 | 92.4 | 121.6 | aspheric | 13.00 | germanium |
| | 7 | 85.8 | 131.1 | spherical | 127.18 | air |
| 2 | 8 | 41.0 | Infinity | | | |

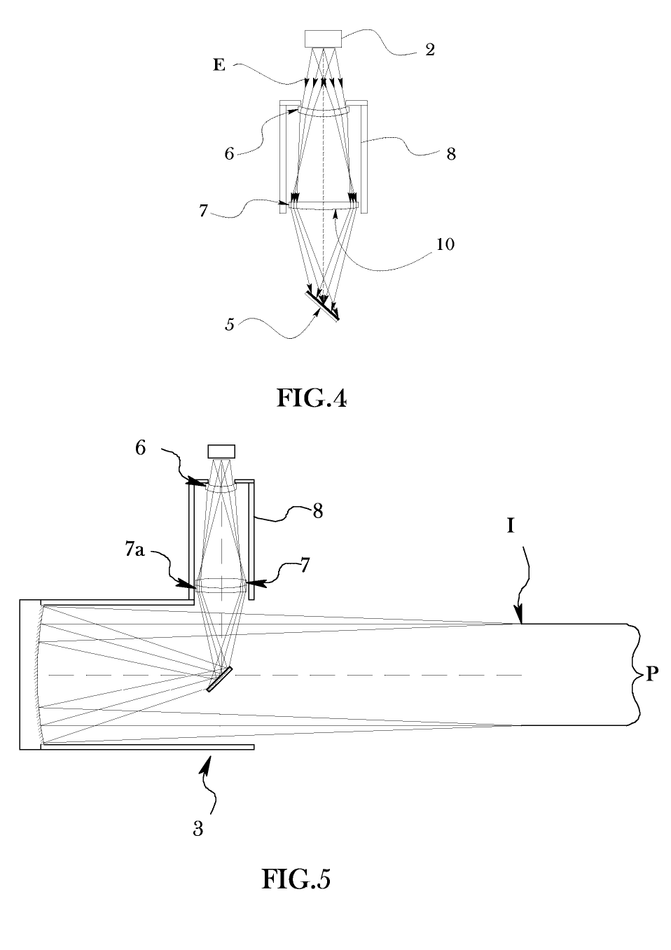

FIG. 4 is a diagrammatic illustration of the refractive portion 8 of the preferred embodiment illustrated in FIG. 3. In this figure, two elements 6 and 7 are predisposed a specified distance from the infrared source object 2 in such a way as to collect optical energy E from said source object and direct it to a focal point proximate to a redirecting flat mirror 5. The first element 6 is aspheric in shape and disposed to direct optical energy towards a second refractive element 7 which is likewise aspheric and includes an additional diffractive phase surface 10 formulated in such a way as to greatly reduce chromatic aberration in the projection optic design.

In FIG. 5 a projection optic 3 according to the present invention of equivalent focal length, angular field of view to the design embodiment depicted in FIG. 4 and likewise with an exit pupil of equivalent size P disposed at a remote position I equal to that of the FIG. 4 design is illustrated. In this variant of the preferred embodiment the refractive imaging portion 8 is configured with an achromatic doublet comprised of differing silicon 7 and germanium 7a refractive materials in place of the preferred embodiments diffractive phase surface, to control the systems chromatic aberrations. This embodiment to the design, aspheric refractive elements 6 and 7 are again utilized to control aberrations in the total projection optic and in so doing provide for diffraction limited imaging over the 3 micron to 5 micron (MWIR) spectral region of the infrared is specified by an optical prescription as follows:

| | | | | | Distance to | Medium |
|---|---|---|---|---|---|---|
| | | Element | Radius of | | Next | Traversed |
| Ref No in | | Diameter | Curvature | Surface | Surface | to Next |
| FIG. | Surface No. | (mm) | (mm) | Type | (mm) | Surface |
| | 0 | 0.0 | Infinity | | Infinity | |
| P | 1 | 254.0 | Infinity | | 1205.00 | |
| 4 | 2 | 350.0 | −948.5 | reflective | 451.42 | air |
| 5 | 3 | 108.1 | Infinity | reflective | 222.25 | air |
| 7 | 4 | 132 | 341.07 | spherical | 21.00 | germanium |
| | 5 | 127 | 187.323 | spherical | 0.038 | air |
| 7a | 6 | 127 | 187.894 | spherical | 20.00 | silicon |
| | 7 | 126 | −845.60 | aspheric | 157.835 | air |
| 6 | 8 | 73 | 108.797 | aspheric | 17.397 | silicon |
| | 9 | 65 | 100.936 | spherical | 83.289 | air |
| 2 | 10 | 41.0 | Infinity | | | |

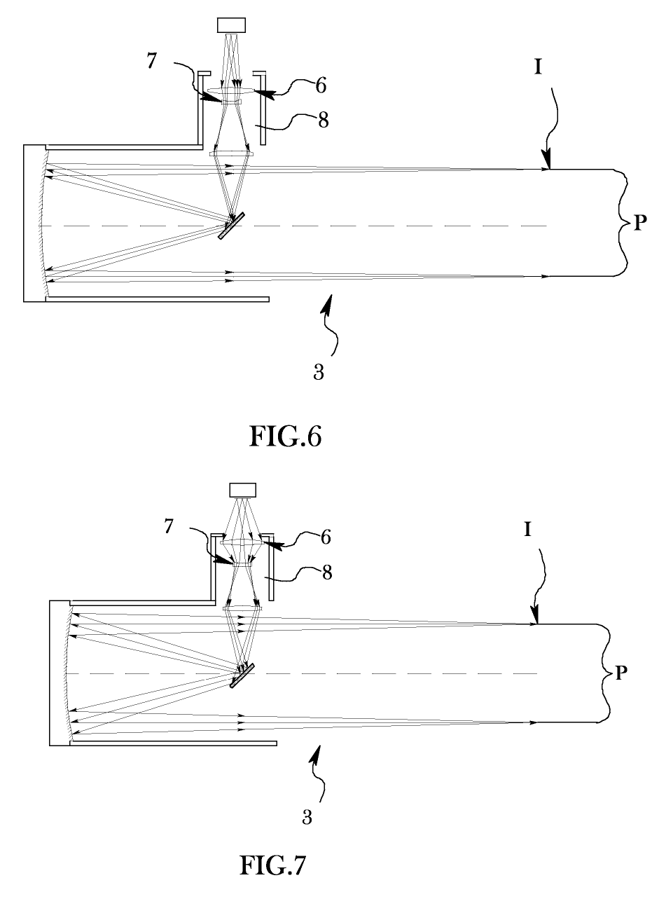

In FIGS. 6 and 7 are shown a variant embodiment of the present invention wherein the refractive imaging portion 8 is configured in a manner as to allow for variable or zoom magnification for the projection optic. This zooming refractive configuration 8 enables the projection optic 3 to provide a variable range of focal lengths to the testing SUT suitable for high quality imaging over the 8 micron to 12 micron range of the infrared spectrum. In this embodiment the relative axial position of one negative aspheric germanium 6 and one positive aspheric germanium 7 element are displaced so as to provide for the focal length variation while simultaneously maintaining high quality performance.

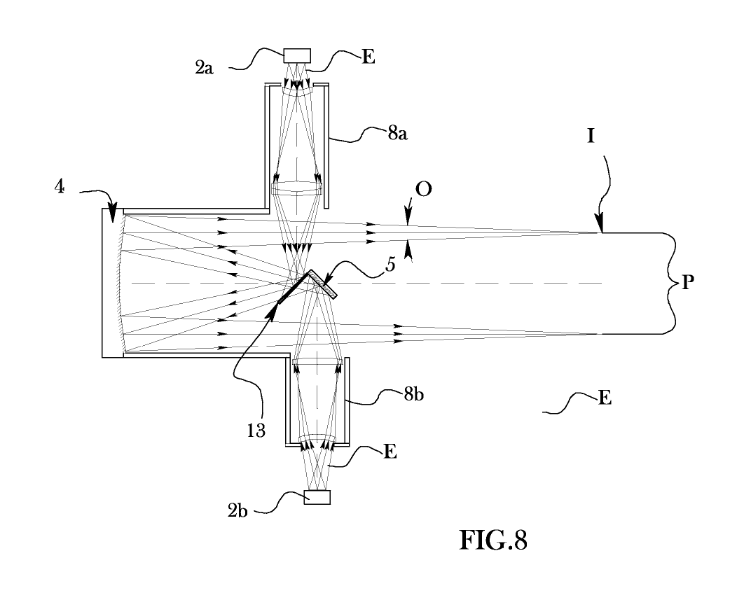

The FIG. 8 illustration depicts a variant of the preferred embodiment of a projection optic 3 in which two individual refractive imaging portions 8a, 8b operate simultaneously. In this configuration energy E from a first scene generator 2a is collected by means of a first refractive imaging group 8a configured in a form similar to that of the preferred embodiment, FIG. 4. The imaging module 8a then directs the energy towards a point proximate to a redirecting flat mirror surface 5 which in turn directs the optical energy towards a large concave mirror surface 4. At a point axially displaced between the flat mirror 5 and the concave mirror 4 is placed a dichroic mirror 13 which allows the optical energy E collected by means of imaging module 8a to pass there through and onto the concave mirror 4. The dichroic mirror 13 is likewise configured to reflect energy E′ from a second imaging module 8b which is designed in a manner to image energy E′ of a different spectral band to that of module 8a and direct said second band of energy E′ towards a point proximate to the dichroic mirror 13. The energy E′ is then reflected by the dichroic mirror 13 towards the concave mirror 4 and in a manner closely similar to that of the energy E collected by the aforementioned first imaging module 8a. This embodiment of the current invention thereby allows for simultaneous delivery of dual wavelength bands of optical energy E, E′ to an SUT without the need for costly projector optic replacement.

What is claimed is:

1. A catadioptric projection optic system which forms an image through a pupil plane external to said projection optic. Said projection optic system comprises: a primary refractive imaging optical portion disposed for collecting optical energy at the projectors focal plane and directing said optical energy towards a secondary reflective imaging portion. Said secondary reflective imaging portion comprises a first mirror disposed to redirect said optical energy towards a second larger concave mirror. Said second concave mirror disposed to collect and direct said energy through a pupil plane positioned external from said projection optic.

2. The projection optical system according to claim 1, wherein said second concave mirror is spherical in form.

3. The projection optical system according to claim 1, wherein said refracting imaging portion includes aspheric surfaces for aberration control.

4. The projection optical system according to claim 3, wherein said refracting imaging portion includes a diffractive surface.

5. A catadioptric projection optic system which forms an image through a pupil plane external to said projection optic. Said projection optic system comprises: one refractive imaging optical portion disposed for collecting the infrared energy at a first focal plane. A first mirror disposed to redirect said energy from first focal plane towards a second larger concave mirror. A second refractive imaging optical portion disposed for collecting the infrared energy at a second focal plane. A dichroic mirror disposed to transmit said energy from said first refractive imaging module and reflect said energy from said second refractive imaging optical portion towards said second larger concave mirror. Said second concave mirror disposed to collect and direct said energy through a pupil plane positioned external from said projection optic.
